(19) United States
(12) Patent Application Publication
(10) Pub. No.: US 2026/0246153 A1
(43) Pub. Date: Aug. 20, 2026

(54) A WAVEGUIDE ANTENNA ARRAY

(71) Applicant: Agency for Science, Technology and Research, Singapore (SG)

(72) Inventors: Yan Yan Zhou, Singapore (SG); Bo Li, Singapore (SG)

(21) Appl. No.: 19/162,196

(22) PCT Filed: Feb. 16, 2024
(86) PCT No.: PCT/SG2024/050084

§ 371 Date: Sep. 4, 2025

(30) Foreign Application Priority Data
Mar. 31, 2023 (SG) 10202300893W

(51) Int. Cl. H01Q 13/28; H01Q 21/00

(52) U.S. Cl. CPC H01Q 13/28; H01Q 21/00

(57) ABSTRACT

This document describes a waveguide antenna array for use in an optical phased array (OPA) such that the OPA is able to achieve a wide field of view and grating-lobe-free far field projection. The waveguide antenna array comprises a first waveguide antenna having periodic perturbations comprising first waveguide sections and first perturbed sections, a second waveguide antenna having periodic perturbations comprising second waveguide sections and second perturbed sections. A pitch between the first and second waveguide antenna is equal or less than half an operating wavelength of an optical signal to be received by the waveguide antenna array. A width of the first waveguide section is different from a width of the second waveguide section. The perturbation period of the first waveguide antenna is different from the perturbation period of the second waveguide antenna.

### RELATED APPLICATION

This application claims the benefit of priority to Singapore patent application no. 10202300893W filed 31 Mar. 2023, the contents of which are hereby incorporated by reference in their entirety for all purposes.

### TECHNICAL FIELD

This application relates to a waveguide antenna array for an optical phased array (OPA) that has a wide field of view and grating-lobe-free far field projection.

### BACKGROUND

Light Detection and Ranging (LiDAR) sensing technology plays a crucial role in various industries, such as in the areas of autonomous vehicles, facial recognition, topographical mapping, space exploration, agriculture, and more. In these areas of technology, an Optical Phased Array (OPA) is typically used as the optical equivalent of the phased array as it enables beam formation, and beam steering over long distances. Its significance lies in its chip-scale design, allowing for compact and integrated photonics chip-based beam steering. Consequently, those skilled in the art are constantly striving to minimize the OPA's size as it not only reduces the chip's physical dimensions but also enhances the integration of various functionalities.

The reduction in the OPA's size is typically achieved by decreasing the regular distance between adjacent antenna pairs in the OPA, i.e., by decreasing the antenna pitch. However, when the antenna pitch becomes too small, this leads to an increase in the OPA's loss due to crosstalk between adjacent antennas which adversely affects the power efficiency of the OPA. The occurrence of crosstalk between antennas imposes physical limitations on the size reduction of OPAs. Conversely, increasing the antenna pitch presents its own set of challenges. If the antenna pitch were to exceed half the operating wavelength of an optical signal that is to be transmitted, this results in the formation of higher-order beams, which are also known as grating lobes. These grating lobes can cause confusion for the detector, which may struggle to distinguish the main beam from these higher-order beams. Hence, in order to avoid the generation of these unwanted beams, an OPA prone to grating lobes is restricted to a smaller scanning range and this significantly narrows its field of view (FOV).

Those skilled in the art have suggested various approaches to address the challenge of achieving an OPA having a wide Field of View (FOV) while having a minimal physical footprint in optical systems. One such approach involves utilizing a one-dimensional edge coupler array to produce grating-lobe-free beam projections. In this approach, the edge couplers are positioned with a half-wavelength pitch, and adjacent waveguides are each designed to mitigate crosstalk. Nonetheless, this one-dimensional antenna array limits the projection to a linear beam, thereby restricting scanning to a single dimension. Additionally, from a manufacturing perspective, fabricating optical-quality end facets for a large number of edge couplers is quite costly and also presents fabrication and packaging challenges.

Another approach proposed by those skilled in the art employs a trapezoidal grating to achieve grating-lobe-free projections. This approach uses a one-dimensional array of waveguides with differing widths to channel input into the trapezoidal grating. Distinct from the approach that employed the edge coupler array, the trapezoidal grating emits light across its entire surface area, directing the light upwards rather than sideways. As a result, the emitted beam forms a two-dimensional circular spot, facilitating two-dimensional scanning capabilities. However, the trapezoidal grating design is monolithic, meaning that the antenna features are interconnected. This design inherently correlates the two steering dimensions (x and y in the plane parallel to the grating surface), leading to several consequences. First, it results in a beam that is not a perfect spot but results in a beam that is distributed across a slightly elongated line. This results in a beam with diminished quality and poor steering resolution and accuracy. Secondly, the correlation between the two steering dimensions necessitates additional measures for independent two-dimensional steering control, thereby increasing the system's overall complexity.

Despite the efforts of those skilled in the art, current techniques are still unable to provide waveguide antennas for an optical phase array (OPA) such that the OPA is able to be integrated into a LIDAR chip, whereby the OPA is able to transmit a grating-lobe-free far field beam when an optical signal having a fundamental mode is beamed through the OPA.

### SUMMARY

In one aspect, the present application discloses a waveguide antenna array. The dual-mode antenna disclosed in the present application comprises a first and a second waveguide antenna. The first waveguide antenna has periodic perturbations along a longitudinal axis of the first waveguide antenna, wherein each perturbation period of the first waveguide antenna comprises a first waveguide section W_{WG1} and a first perturbed section W_{Per1}; while the second waveguide antenna has periodic perturbations along a longitudinal axis of the second waveguide antenna, wherein each perturbation period of the second waveguide antenna comprises a second waveguide section W_{WG2} and a second perturbed section W_{Per2}. A pitch P_{A} between the first and second waveguide antenna is formed to be equal or less than half an operating wavelength of an optical signal received by the waveguide antenna array, a width of the first waveguide section W_{WG1} is formed to be different from a width of the second waveguide section W_{WG2}, and the perturbation period of the first waveguide antenna ρ₁ is set to be different from the perturbation period of the second waveguide antenna ρ₂.

In a further embodiment of this aspect, the width of the first waveguide section W_{WG1} is different from the width of the second waveguide section W_{WG2} by 30 nm or more, the width of the first perturbed section W_{Per1} is different from the width of the second perturbed section W_{Per2}, and a difference in width 2·ΔW_{Per1} between the width of the first waveguide section W_{WG1} and the first perturbed section W_{Per1} is different from a difference in width 2·ΔW_{Per2} between the width of the second waveguide section W_{WG2} and the second perturbed section W_{Per2}.

In a further embodiment of this aspect, the waveguide antenna array further comprises a third waveguide antenna having periodic perturbations along a longitudinal axis of the third waveguide antenna, wherein each perturbation period of the third waveguide antenna comprises a third waveguide section W_{WG3} and a third perturbed section W_{Per3}. A pitch P_{A} between the second and third waveguide antenna is formed to be no more than half an operating wavelength of an optical signal received by the waveguide antenna array, a width of the third waveguide section W_{WG3} is formed to be different from the widths of the first W_{WG1} and second W_{WG2} waveguide sections, and the perturbation period of the third waveguide antenna ρ₃ is different from the perturbation periods of the first ρ₁ and second ρ₂ waveguide antennas.

In another aspect, the present application discloses a method of forming a waveguide antenna array, the method comprising the steps of forming a first waveguide antenna having periodic perturbations along a longitudinal axis of the first waveguide antenna, wherein each perturbation period of the first waveguide antenna comprises a first waveguide section W_{WG1} and a first perturbed section W_{Per1}; and forming a second waveguide antenna having periodic perturbations along a longitudinal axis of the second waveguide antenna, wherein each perturbation period of the second waveguide antenna comprises a second waveguide section W_{WG2} and a second perturbed section W_{Per2}. A pitch P_{A} between the first and second waveguide antenna is formed to be equal or less than half an operating wavelength of an optical signal received by the waveguide antenna array, a width of the first waveguide section W_{WG1} is formed to be different from a width of the second waveguide section W_{WG2}, and the perturbation period of the first waveguide antenna ρ₁ is set to be different from the perturbation period of the second waveguide antenna ρ₂.

In a further embodiment of this another aspect, the width of the first waveguide section W_{WG1} is formed to be different from the width of the second waveguide section W_{WG2} by 30 nm or more, the width of the first perturbed section W_{Per1} is formed to be different from the width of the second perturbed section W_{Per2}, and a difference in width 2·ΔW_{Per1} between the width of the first waveguide section W_{WG1} and the first perturbed section W_{Per1} is formed to be different from a difference in width 2·ΔW_{Per2} between the width of the second waveguide section W_{WG2} and the second perturbed section W_{Per2}.

In yet another aspect, the present application discloses an optical phased array system that comprises a plurality of waveguide antenna arrays, whereby each waveguide antenna array comprises a first and a second waveguide antenna. The first waveguide antenna has periodic perturbations along a longitudinal axis of the first waveguide antenna, wherein each perturbation period of the first waveguide antenna comprises a first waveguide section W_{WG1} and a first perturbed section W_{Per1}; while the second waveguide antenna has periodic perturbations along a longitudinal axis of the second waveguide antenna, wherein each perturbation period of the second waveguide antenna comprises a second waveguide section W_{WG2} and a second perturbed section W_{Per2}. A pitch P_{A} between the first and second waveguide antenna is formed to be equal or less than half an operating wavelength of an optical signal received by the waveguide antenna array, a width of the first waveguide section W_{WG1} is formed to be different from a width of the second waveguide section W_{WG2}, and the perturbation period of the first waveguide antenna ρ₁ is set to be different from the perturbation period of the second waveguide antenna ρ₂.

### BRIEF DESCRIPTION OF THE DRAWINGS

Various embodiments of the present disclosure are described below with reference to the following drawings:

FIG. 1 illustrates an isometric view of a waveguide antenna array in accordance with an embodiment of the present disclosure;

FIG. 2 illustrates a top-view line drawing of the waveguide antenna array illustrated in FIG. 1;

FIG. 3 illustrates a plot showing a relationship between effective refractive index η_{eff} and a width of a standard waveguide antenna;

FIG. 4 an isometric view of a waveguide antenna array in accordance with another embodiment of the present disclosure;

FIG. 5 illustrates a top-view line drawing of the waveguide antenna array illustrated in FIG. 4;

FIG. 6 illustrates a process for determining optimal widths for perturbed sections of waveguide antennas of the waveguide antenna array in accordance with embodiments of the disclosure;

FIG. 7 illustrates a process for forming a waveguide antenna array having two waveguide antennas in accordance with embodiments of the present disclosure;

FIG. 8 illustrates a simulated near field distribution of three antennas having identical physical dimensions and having an antenna pitch of a half-wavelength of the fundamental mode of an optical signal, when the optical signal having the fundamental mode is injected into the waveguide antenna in the middle of the structure;

FIG. 9 illustrates a simulated near field distribution of three antennas designed in accordance with embodiments of the present disclosure, when an optical signal having a fundamental mode is injected into the waveguide antenna in the middle of the structure;

FIG. 10(a) illustrates an array of waveguide antenna arrays designed in accordance with embodiments of the present disclosure; and

FIG. 10(b) illustrates a simulated angular distribution of the electric field that was projected 1 meter away from the array of waveguide antenna arrays illustrated in FIG. 10(a), when optical signals having the same fundamental mode are injected into each of the waveguide antennas in the array of waveguide antenna arrays.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

As used herein, “a periodic perturbation” means including, but not limited to, a regular, repeating disturbance or alteration in the physical characteristics of a structure or an object and is often used to describe a systemic change in a structure or material.

As used herein, the terms “first,” “second,” and the like in the description, in the claims, and in the figures are used for distinguishing between similar objects and not necessarily for describing a particular sequential or chronological order.

A waveguide antenna array comprises multiple individual waveguide antennas arranged in a specific configuration. This arrangement of multiple individual waveguide antennas enables the waveguide antenna array to achieve enhanced performance characteristics such as improved directivity, better gain, and more accurate beam steering capability. Each element in the array comprises a waveguide antenna, which is essentially a waveguide structure that is designed to guide and emit electromagnetic waves in a particular direction. By arranging multiple waveguide antennas in an array, the resulting system is able to manipulate the radiation pattern more effectively through the constructive interference of the waves that are emitted in specific directions thereby enhancing the antenna gain in those directions while reducing it in others. This results in the emission of a more focused and directed beam.

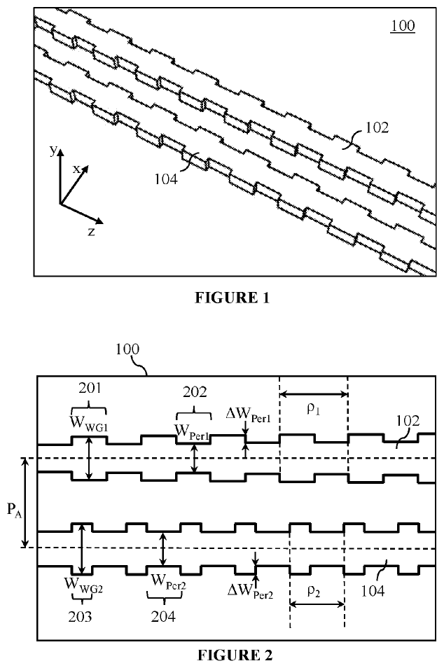

An isometric view of a waveguide antenna array in accordance with embodiments of the disclosure is illustrated in FIG. 1. In this embodiment, waveguide antenna array 100 comprises two waveguide antennas, which are waveguide antennas 102 and 104. Waveguide antenna 102 is designed to have periodic perturbations along a longitudinal axis of waveguide antenna 102 (along the z-axis) and waveguide antenna 104 is designed to have periodic perturbations along a longitudinal axis of waveguide antenna 104 (along the z-axis). Optical signals propagating along the longitudinal axis of these waveguide antennas will be emitted out along the y-axis of these antennas. As illustrated in FIG. 2, it can be seen that the periodic perturbation of each of the waveguide antennas comprises a waveguide section and a perturbed section. In particular, waveguide antenna 102 has perturbation period ρ₁, whose length is defined by waveguide section 201 having a width of W_{WG1} and perturbed section 202 having a width of W_{Per1}, while waveguide antenna 104 has perturbation period ρ₂, whose length is defined by waveguide section 203 having a width of W_{WG2} and perturbed section 203 having a width of W_{Per2}. Further, as illustrated in FIG. 2, the antenna pitch P_{A} of waveguide antenna array 100 is defined as the center-to-center spacing between waveguide antenna 102 and waveguide antenna 104. In further embodiments of the present disclosure, antenna pitch P_{A} is set to be equal or less than half the operating wavelength of an optical signal that is to be received by waveguide antenna array 100.

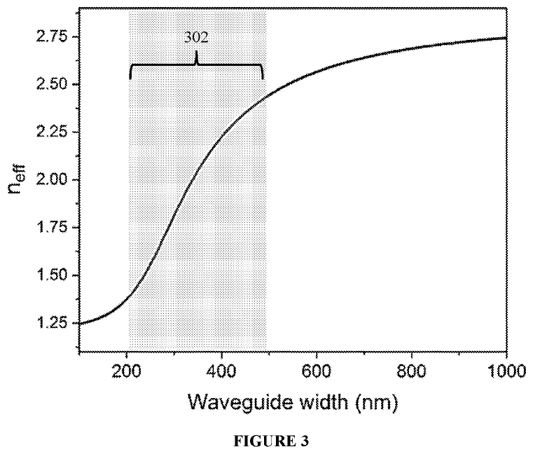

In embodiments of the disclosure, the width W_{WG1} of waveguide section 201 and the width W_{WG2} of waveguide section 203 may comprise any value between 200 nm and 500 nm. The widths of the waveguide sections of the waveguide antennas were chosen from these ranges of values as it was determined that the waveguide mode within the waveguide antennas changes the most when the widths of the waveguide sections of the waveguide antennas were selected from these values. A plot showing the relationship between the effective refractive index η_{eff} in a standard waveguide and the width of the waveguide is illustrated in FIG. 3. The plot in section 302 illustrates that when the width of the waveguide antenna is between 200 nm and 500 nm, the effective refractive index η_{eff} in the waveguide antenna changes the most, i.e., has the steepest gradient of around 1.92/μm. It is desirable to select a waveguide width from a range where the waveguide mode or where the effective refractive index η_{eff} in the waveguide changes the most drastically as this steep relationship allows for fine control over the mode characteristics of the waveguide antenna which in turn allows for effective discrimination between different modes of the waveguide antenna.

In embodiments of the disclosure, the width W_{WG1} of waveguide section 201 of waveguide antenna 102 may be designed to be bigger or smaller than the width W_{WG2} of waveguide section 203 of waveguide antenna 104, i.e., the width W_{WG1} of waveguide section 201 is different from the width W_{WG2} of waveguide section 203 (W_{WG1}≠W_{WG2}). This is to ensure that the modes in these waveguide antennas are sufficiently different so that minimal crosstalk will occur between these waveguides as optical signals propagate through. In embodiments of the disclosure, the difference in width between the width W_{WG1} of waveguide section 201 and the width W_{WG2} of waveguide section 203 is designed to be at least 30 nm or more.

Additionally, perturbation ΔW_{Per1}, which is half of the difference in width between the width W_{WG1} of waveguide section 201 and the width W_{Per1} of perturbed section 202, is different from perturbation ΔW_{Pre2}, which is half of the difference in width between the width W_{WG2} of waveguide section 203 and the width W_{Per2} of the second perturbed section 204. As the optical signals propagate along the periodically perturbed longitudinal axis of waveguide antennas 102 and 104, these optical signals will encounter perturbations ΔW_{Per1} and ΔW_{Per2}. These perturbations cause the optical signals to scatter at a slower rate as these optical signals propagate through the waveguide antennas and as these optical signals are emitted from the y-axes of these two antennas. The sizes of perturbations ΔW_{Per1} and ΔW_{Per2} are typically small and may be the range between 30 nm and 200 nm, depending on fabrication tolerances and the width of the original waveguide. Due to the slow scattering rate of optical signals in these waveguide antennas, it allows for these waveguide antennas to be used in an optical phased array (OPA) system that has a large aperture and small chip footprint. The OPA system is therefore above to achieve emitted signals with smaller beam divergence and higher steering resolution.

In embodiments of this disclosure, the perturbation period ρ₁ of waveguide antenna 102 is set to be different from the perturbation period ρ₂ of waveguide antenna 104 (ρ₁·ρ₂) and the width W_{Per1} of perturbed section 202 is set to be different from the width W_{Per2} of perturbed section 204 (W_{Per1}≠W_{Per2}). It should be noted that although the physical parameters (i.e., W_{WG1}, ΔW_{Per1}, ρ₁) of waveguide antenna 102 are different from the physical parameters of waveguide antenna 104, these physical parameters are selected such that the optical signals emitted from these two waveguide antennas are at the same emission angle θ and at the same rate of power emission. The detailed method for selecting the values for these physical parameters will be discussed in greater detail in the subsequent sections.

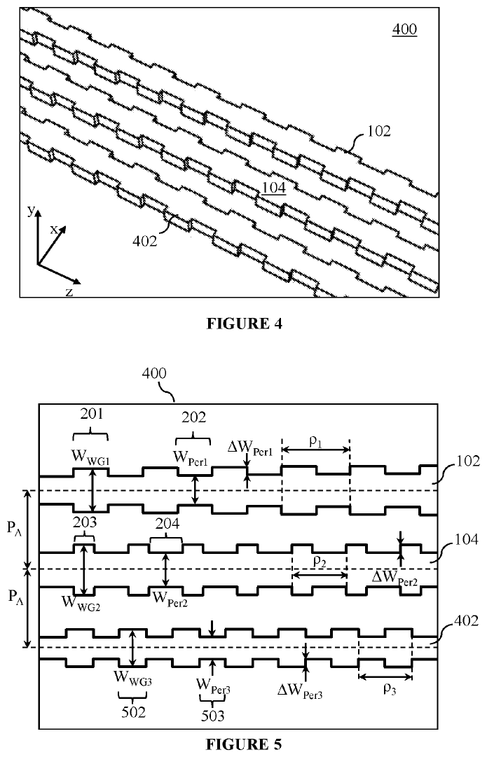

An isometric view of a waveguide antenna array in accordance with another embodiment of the disclosure is illustrated in FIG. 4. In this embodiment, waveguide antenna array 400 comprises of three waveguide antennas which comprise of the previously mentioned waveguide antenna 102, the previously mentioned waveguide antenna 104, and newly introduced waveguide antenna 402, which has periodic perturbations along a longitudinal axis of waveguide antenna 402 (along the z-axis). As illustrated in FIG. 4, it can be seen that waveguide antenna 402 has perturbation period ρ₃, whose length is defined by waveguide section 502 having a width of W_{WG3} and perturbed section 503 having a width of W_{Per3}. Further, as illustrated in FIG. 4, each adjacent waveguide antenna is separated by an antenna pitch P_{A}, which is set to be equal to or less than half the operating wavelength of an optical signal that is to be received by waveguide antenna array 400.

In embodiments of the disclosure, the widths W_{WG1}, W_{WG2} and W_{WG3} of waveguide sections 201, 203 and 502 may comprise any value between 200 nm and 500 nm. However, all of the widths W_{WG1}, W_{WG2} and W_{WG3} of waveguide sections 201, 203 and 502 are different from each other, i.e., the width W_{WG1} of waveguide section 201 is not equal to the width W_{WG2} of waveguide section 203 and is not equal to the width W_{WG3} of waveguide section 502 (W_{WG1}≠W_{WG2}*W_{WG3}). As discussed in relation to the previous embodiment of the disclosure, this is to ensure that the modes in these waveguide antennas are sufficiently different so that crosstalk does not occur between these waveguides as optical signals propagate through these waveguides. In embodiments of the disclosure, the difference in width between the width W_{WG1} of waveguide section 201 and the width W_{WG2} of waveguide section 203 and the width W_{WG3} of waveguide section 502 is at least 30 nm or more. For example, the width W_{WG1} of waveguide section 201 may be chosen to be 400 nm, the width W_{WG2} of waveguide section 203 may be chosen to be 450 nm and the width W_{WG3} of waveguide section 502 may be chosen to be 500 nm.

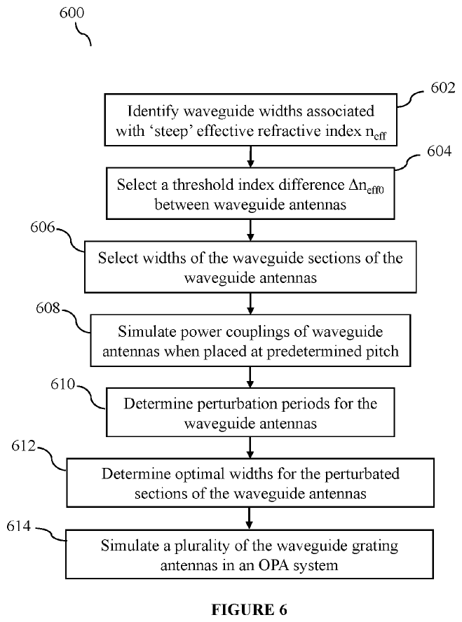

In embodiments of this disclosure, the perturbation period ρ₁ of waveguide antenna 102 is set to be different from the perturbation period ρ₂ of waveguide antenna 104 and from the perturbation period ρ₃ of waveguide antenna 402 (ρ₁≠ρ₂*ρ₃) and the widths W_{Per1}, W_{Per2}, W_{Per3} are all set to be different from each other (W_{Per1}*W_{Per2}≠W_{Per3}). Additionally, the perturbations ΔW_{Per1}, ΔW_{Per2} and ΔW_{Per3} (which is half of the difference in width between the width W_{WG3} of waveguide section 502 and the width W_{Per3} of the second perturbed section 503), are all set to be different from each other as well (ΔW_{Per1}≠ΔW_{Per2}≠ΔW_{Per3}). It should be noted that although the physical parameters (i.e., W_{WG1}, ΔW_{Per1}, ρ₁) of these three waveguide antennas 102, 104 and 402 are all different each other, these physical parameters are selected such that the optical signals emitted from these three waveguide antennas are at the same emission angle θ and at the same rate of power emission. Through the use of the optimization method described in FIG. 6, the optimal perturbation widths may be determined to be W_{Per1}=355 nm, W_{Per2}=380 nm, W_{Per3}=400 nm, when the operating wavelength λ of the optical signal propagating through the waveguide antenna array is set as 1550 nm and the antenna pitch between the three waveguide antennas is set to be 775 nm i.e.,

$$( i . e . , {P}_{A} = \frac{λ}{2} ) .$$

As a result, the perturbation periods may then be determined to be ρ₁=756 nm, ρ₂=720 nm, ρ₃=696 nm where the duty cycle (DC) between the waveguide and perturbed sections is set at 50%.

In embodiments of the disclosure, these waveguide antennas may comprise, but are not limited to, silicon having a thickness of 220 nm and formed on silicon dioxide substrates and buried in silicon dioxide superstrates (TOX). In other embodiments of the disclosure, the material of the waveguide antennas may comprise silicon nitride (SiN), aluminum nitride (AlN), titanium dioxide (TiO₂) or any other materials that are transparent and will allow light to pass through.

One skilled in the art will recognize that each of the embodiments described in the sections above may be used to form an Optical Phased Array (OPA) having a large aperture size when a plurality of either of the embodiments of the waveguide antenna arrays are arranged in a repeating series.

FIG. 6 illustrates process 600 for determining optimal widths for perturbed sections of waveguide antennas of the waveguide antenna array in accordance with embodiments of the disclosure, whereby process 600 may be implemented in a computing module (not shown) or by modules and/or components in a computer system (not shown). The detailed workings of the computer module and computer system have been omitted from this description for brevity as these components are well known to one skilled in the art.

Process 600 begins at step 602 whereby process 600 first determines widths of each of the waveguide antennas of the waveguide antenna array based on the effective refractive indexes η_{eff} of each of the waveguide antennas. This is achieved by process 600 first identifying effective refractive indexes η_{eff} of a waveguide antenna that exhibits the most significant change in response to variations in the width of the waveguide antenna. In embodiments of the disclosure, process 600 may utilize a previously generated plot that shows the relationship between effective refractive indexes η_{eff} of a waveguide as the width of the waveguide varies, (such as the plot illustrated in FIG. 3) to identify suitable effective refractive indexes η_{eff}. The width of the waveguide section of each of the waveguide antennas is then selected based on the range of waveguide widths associated with these identified effective refractive indexes η_{eff}.

At step 604, process 600 then determines a value for the threshold index difference Δn_{eff0} between each of the waveguide antennas in the waveguide antenna array. It should be noted that the threshold index difference Δn_{eff0} is used to determine the minimum width difference between the widths of the waveguide sections of any two adjacent waveguide antennas in the waveguide antenna array. For example, when the threshold index difference Δn_{eff0} between two waveguide antennas is set as 0.05, the minimum width difference between the widths of the waveguide sections of any adjacent two waveguide antennas is set to be about 50 nm. The relationship between the threshold index difference Δn_{eff0} and the widths of the waveguide sections of any adjacent two waveguide antennas may be obtained from a graph such as the graph plotted in FIG. 3.

Once the value for the threshold index difference Δn_{eff0} has been determined, process 600 then proceeds to step 606. At this step, the widths of the waveguide antennas are set such that the difference in effective refractive indexes Δn_{eff} between any two adjacent waveguide antennas is greater than or equal to the determined threshold index difference Δn_{eff0}.

Process 600 then proceeds to step 608, whereby process 600 simulates power couplings between each of the waveguide antennas when the overall length of each waveguide is set to be identical and when the antenna pitch between each of the waveguide antennas is set to be half an operating wavelength of an optical signal that is to be received by the waveguide antenna array. Process 600 performs this simulation step to ensure that no grating lobes will be formed.

At step 610, process 600 will then determine the initial perturbation periods for each of the waveguide antennas. This is done by first setting the width of the waveguide section of each waveguide antenna based on the width of each respective waveguide antenna—as determined in previous step 606. Process 600 then subsequently determines the width of the perturbation section of each waveguide antenna. As mentioned in the previous sections, it should be noted that the widths of the waveguide section and perturbation section of each waveguide antenna are different from the corresponding widths of other waveguide antennas in the waveguide antenna array. A grating equation is then used to determine the perturbation period of each of the waveguide antennas, where the length of each perturbation period p may be defined as:

$$ρ = λ ( {η}_{eff , wa} - {η}_{TOX} sin θ ) \qquad ( 1 )$$

where η_{TOX} is defined as the refractive index of the superstrate of the waveguide antenna array, θ is defined as the emission angle of the waveguide antenna, λ is defined as the wavelength of a mode propagating through the waveguide and η_{eff,wa} is the effective refractive index of a mode propagating through the waveguide antenna and may be defined as:

$${η}_{eff , wa} = {η}_{eff , wg} DC + {η}_{eff , Per} ( 1 - DC ) \qquad ( 2 )$$

where η_{eff,wg} is defined as the effective refractive index of a mode propagating through the waveguide section, η_{eff,Per} is defined as the effective refractive index of a mode propagating through the perturbation section, and DC is defined as the duty cycle of the waveguide and perturbation sections.

Process 600 then proceeds to step 612. At this step, process 600 will proceed to determine optimal widths of perturbed sections of the waveguide antennas by using an optimizer, such as, but is not limited to, a Particle Swarm Optimization (PSO) algorithm. An objective function of the PSO algorithm is to minimize the differences in power emission rates and emission angles between the waveguide antennas when an optical signal was received and emitted by the waveguide antennas. In order to achieve this, the PSO algorithm will generate iterations of the widths of the perturbed sections until the algorithm is able to determine widths of the perturbed sections for each of the waveguide antennas that allow all the waveguide antennas in the waveguide antenna array to have similar power emission rates and similar emission angles when an optical signal was received and emitted by the waveguide antennas. Once the optimal widths of the perturbed sections of the waveguide antennas have been determined, process 600 will then proceed to step 614. At this step, process 600 will simulate the performance of an OPA that has a plurality of the waveguide antenna arrays based on the physical parameters obtained in steps 602-612. Process 600 then ends.

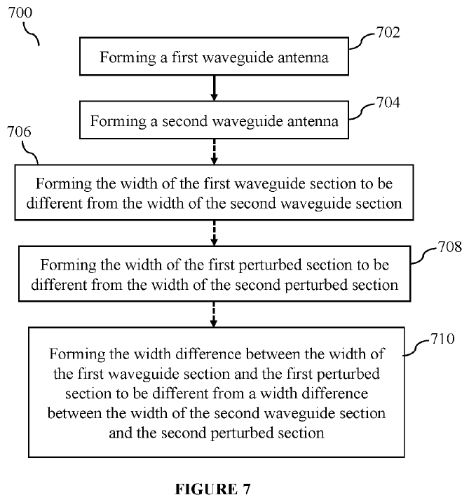

FIG. 7 illustrates process 700 for forming a waveguide antenna array in accordance with embodiments of the present disclosure. Process 700 begins at step 702 whereby a first waveguide antenna having periodic perturbations along a longitudinal axis of the first waveguide antenna is first formed. Each perturbation period of the first waveguide antenna is formed with a first waveguide section and a first perturbed section. At step 704, a second waveguide antenna having periodic perturbations along a longitudinal axis of the second waveguide antenna is then formed. Similarly, each perturbation period of the second waveguide antenna is formed with a second waveguide section and a second perturbed section. During the formation of the first and second waveguide antennas, the center-to-center spacing between these two waveguide antennas (i.e., antenna spacing) is set such that it is equal or less than half an operating wavelength of an optical signal that is to be received by the waveguide antenna array.

Process 700 ensures at step 706 that the width of the first waveguide section is formed to be different from the width of the second waveguide section. At step 708, process 700 then ensures that the perturbation period of the first waveguide antenna is determined to be different from the perturbation period of the second waveguide antenna. Once this is done, process 700 then proceeds to ensure that the width difference between the width of the first waveguide section and the first perturbed section is different from a width difference between the width of the second waveguide section and the second perturbed section. This takes place at step 710.

In further embodiments of the disclosure, process 700 may ensure that the width of the first waveguide section is formed to be different from the width of the second waveguide section by 30 nm or more. In still further embodiments of the disclosure, process 700 determines the perturbation period of each of the waveguide antennas based on the operating wavelength of the optical signal received by the waveguide antenna array, a refractive index of a superstrate of the waveguide antenna array, an effective refractive index of a mode propagating in the waveguide antenna and an emission angle of the waveguide antenna.

In this embodiment of the disclosure, process 700 determines the effective refractive index of the mode propagating in the waveguide antenna based on an effective refractive index of a mode propagating in the waveguide section of the waveguide antenna, an effective refractive index of a mode propagating in the perturbed section of the waveguide antenna and a duty cycle of the waveguide antenna.

In a further embodiment of the disclosure, process 700 utilizes a Particle Swarm Optimization (PSO) algorithm to iterate and optimize the widths of the first and second perturbed sections, whereby an objective function of the PSO algorithm is to minimize differences in power emission rates and emission angles between the first and second waveguide antennas when the optical signal was received by the waveguide antenna array.

In further embodiments of the disclosure, process 700 forms a third waveguide antenna having periodic perturbations along a longitudinal axis of the third waveguide antenna, wherein each perturbation period of the third waveguide antenna comprises a third waveguide section and a third perturbed section. Process 700 will also ensure that a pitch between the first, second and third waveguide antenna is formed to be no more than half an operating wavelength of an optical signal to be received by the waveguide antenna array, a width of the third waveguide section is formed to be different from the widths of the first and second waveguide sections, and the perturbation period of the third waveguide antenna is formed to be different from the perturbation periods of the first and second waveguide antennas.

### Simulation Results

To simulate the performance of the dual-mode waveguide antenna designed in accordance with the steps set out in the previous section, a Finite-difference time-domain (FDTD) method was used to numerically study the crosstalk and the far field projection pattern of a waveguide antenna array comprising of three waveguide antennas. As for the effective mode indices of the waveguide antenna, a Finite-element method (FEM) was used to calculate these values.

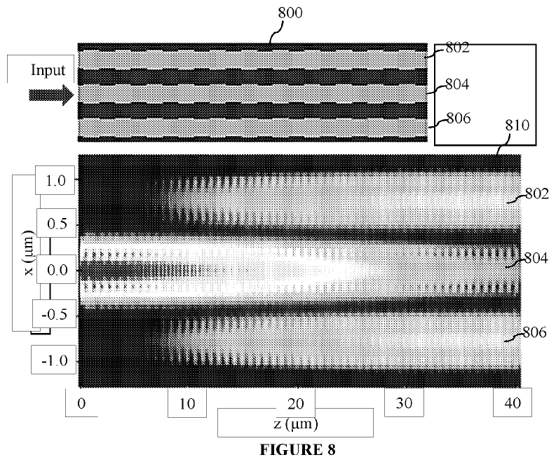

FIG. 8 illustrates a top-view schematic 800 of a trio of identical waveguide antennas 802, 804, and 806, where all three waveguide antennas have an antenna pitch of half a wavelength of the fundamental mode. In this simulation, waveguide antennas 802, 804, and 806 are designed to operate in a configuration where an optical signal having a fundamental mode is injected into the central waveguide, i.e. waveguide antenna 804. Additionally, each antenna in this setup is designed identically, i.e. all the antennas have the same physical parameters, ensuring consistency in the behavior and characteristics of each waveguide.

From the simulated field pattern 810, it can be seen that a rapid transfer of light occurs from the central waveguide to the adjacent ones when the optical signal is injected into the central waveguide. This quick dispersion of light energy into the neighboring waveguides leads to significant losses. These losses are primarily attributed to the occurrence of crosstalk between waveguide antennas 802, 804, and 806. In such a scenario, the efficiency of the system is reduced due to the loss of light energy as the injected light leaks into adjacent waveguides through the crosstalk effect.

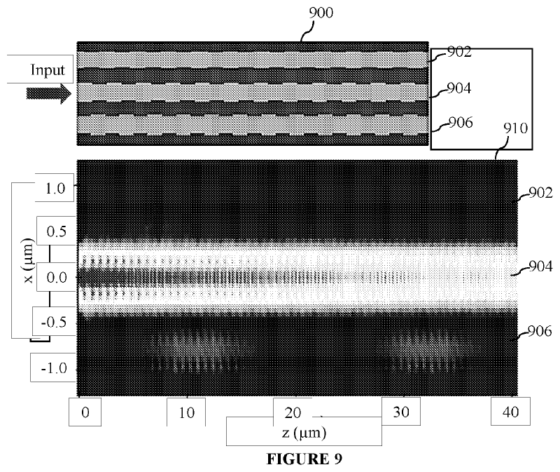

FIG. 9 illustrates a top-view schematic 900 of a waveguide antenna array comprising waveguide antennas 902, 904, and 906, designed in accordance with embodiments of the disclosure, where all three waveguide antennas have an antenna pitch of half a wavelength of the fundamental mode. In this simulation, waveguide antennas 902, 904, and 906 are designed to operate in a configuration where an optical signal having a fundamental mode is injected into the central waveguide, i.e. waveguide antenna 904.

Unlike the simulated field pattern in FIG. 8, from the simulated field pattern 910, it can be seen that there is negligible dispersion of light energy from waveguide antenna 904 into adjacent waveguides 902 and 906 when the optical signal is injected into waveguide antenna 904. As shown, the waveguide antenna array designed in accordance with embodiments of the disclosure was able to propagate an optical signal having a fundamental mode through the waveguide antenna array with minimal crosstalk occurring between adjacent waveguide antennas.

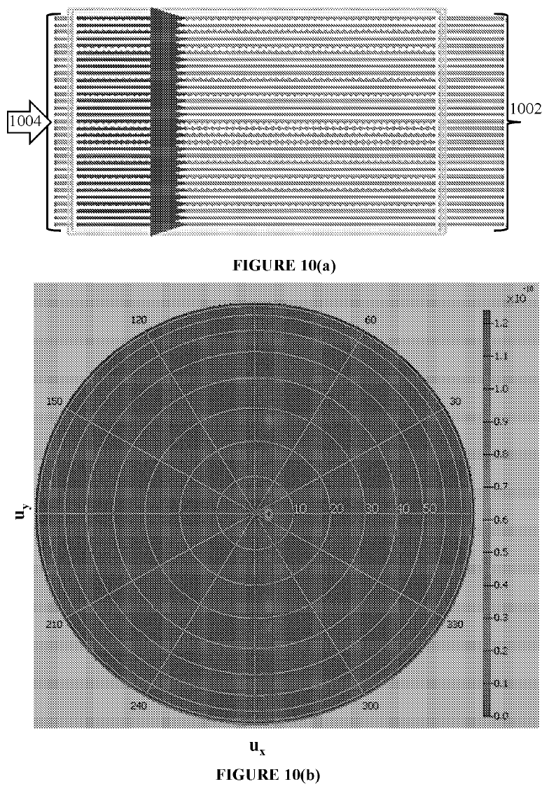

Subsequently, a miniature optical phased array (OPA) system was formed from a plurality of waveguide antenna arrays arranged in a repeating series, whereby each of the waveguide antenna arrays were designed in accordance with embodiments of the present disclosure. As shown in FIG. 10(a), the miniature OPA system comprises a plurality of waveguide antenna arrays 1002 arranged in a repeating series. In this simulation, each waveguide antenna in the miniature OPA system is injected at the beginning with optical signal 1004, that has a fundamental mode.

Angular distributions of the electric field that are projected up to 1 m away from the OPA illustrated in FIG. 10(a) are simulated and plotted in FIG. 10(b). This plot illustrates components of vectors in a spherical coordinate system that has been projected onto a Cartesian coordinate system. An x-component uₓ of a vector in this plot, is defined as uₓ=sin(θ)cos(φ), while a y-component u_{y} of the vector in this plot is defined as u_{y}=sin(θ)sin(φ), where θ and φ are the polar and azimuthal angles respectively of the vector in spherical coordinates.

From the plot shown in FIG. 10(b), it can be seen that a well-defined circular spot is formed at φ=0°, θ=3.55° when each waveguide antenna in the miniature OPA system is injected at the beginning with optical signal 1004. No other beams can be observed from this plot, confirming the fact that an OPA formed from a plurality of waveguide antenna arrays (as described in accordance with embodiments of the disclosure) arranged in a repeating series is able to create grating-lobe-free projections. Although the plot shows some scattering occurring in the background of the far field projections, this is not of concern as it was determined that this scattering occurred due to noise generated by the simulator. It is useful to note that the simulator tends to generate such noisy projections when the simulator was used on an OPA having a small number of elements. Such noisy projections tend to disappear when the simulator was used on an OPA having hundreds and thousands of elements.

Numerous other changes, substitutions, variations, and modifications may be ascertained by the skilled in the art and it is intended that the present application encompass all such changes, substitutions, variations, and modifications as falling within the scope of the appended claims.

1. A waveguide antenna array comprising:
a first waveguide antenna having periodic perturbations along a longitudinal axis of the first waveguide antenna, wherein a periodic perturbation of the first waveguide antenna comprises a first waveguide section and a first perturbed section; and
a second waveguide antenna having periodic perturbations along a longitudinal axis of the second waveguide antenna, wherein a periodic perturbation of the second waveguide antenna comprises a second waveguide section and a second perturbed section,
whereby a pitch between the first and second waveguide antenna is equal or less than half an operating wavelength of an optical signal to be received by the waveguide antenna array,
whereby a width of the first waveguide section is different from a width of the second waveguide section, and
whereby the perturbation period of the first waveguide antenna is different from the perturbation period of the second waveguide antenna.

2. The waveguide antenna array according to claim 1, wherein the width of the first waveguide section is different from the width of the second waveguide section by 30 nm or more.

3. The waveguide antenna array according to claim 1, whereby the width of the first perturbed section is different from the width of the second perturbed section.

4. The waveguide antenna array according to claim 1, whereby a difference in width between the width of the first waveguide section and the first perturbed section is different from a difference in width between the width of the second waveguide section and the second perturbed section.

5. The waveguide antenna array according to claim 1, whereby the perturbation period of each of the waveguide antennas is determined based on the operating wavelength of the optical signal received by the waveguide antenna array, a refractive index of a superstrate of the waveguide antenna array, an effective refractive index of a mode propagating in the waveguide antenna and an emission angle of the waveguide antenna.

6. The waveguide antenna array according to claim 5, whereby the effective refractive index of the mode propagating in the waveguide antenna is determined based on an effective refractive index of a mode propagating in the waveguide section of the waveguide antenna, an effective refractive index of a mode propagating in the perturbed section of the waveguide antenna and a duty cycle of the waveguide antenna.

7. The waveguide antenna array according to claim 6, whereby an optimal width of the first perturbed section and an optimal width of the second perturbed section are determined based on iterations of the widths of the first and second perturbed sections that allow the first and second waveguide antennas to have similar power emission rates and similar emission angles when the optical signal was received by the waveguide antenna array.

8. The waveguide antenna array according to claim 7, whereby a Particle Swarm Optimization (PSO) algorithm is used to iterate and optimize the widths of the first and second perturbed sections, whereby an objective function of the PSO algorithm is to minimize differences in power emission rates and emission angles between the first and second waveguide antennas when the optical signal was received by the waveguide antenna array.

9. The waveguide antenna array according to claim 1 further comprising:
a third waveguide antenna having periodic perturbations along a longitudinal axis of the third waveguide antenna, wherein each perturbation period of the third waveguide antenna comprises a third waveguide section and a third perturbed section;
whereby a pitch between the second and third waveguide antenna is no more than half an operating wavelength of an optical signal to be received by the waveguide antenna array,
whereby a width of the third waveguide section is different from the widths of the first and second waveguide sections, and
whereby the perturbation period of the third waveguide antenna is different from the perturbation periods of the first and second waveguide antennas.

10. The waveguide antenna array according to claim 1 wherein each of the waveguide sections of the waveguide antennas have a width between 200 nm and 500 nm.

11. A method of forming a waveguide antenna array comprising:
forming a first waveguide antenna having periodic perturbations along a longitudinal axis of the first waveguide antenna, wherein each perturbation period of the first waveguide antenna comprises a first waveguide section and a first perturbed section; and
forming a second waveguide antenna having periodic perturbations along a longitudinal axis of the second waveguide antenna, wherein each perturbation period of the second waveguide antenna comprises a second waveguide section and a second perturbed section,
whereby a pitch between the first and second waveguide antenna is formed to be equal or less than half an operating wavelength of an optical signal to be received by the waveguide antenna array,
whereby a width of the first waveguide section is formed to be different from a width of the second waveguide section, and
whereby the perturbation period of the first waveguide antenna is determined to be different from the perturbation period of the second waveguide antenna.

12. The method according to claim 11, wherein the width of the first waveguide section is formed to be different from the width of the second waveguide section by 30 nm or more.

13. The method according to claim 11, whereby the width of the first perturbed section is formed to be different from the width of the second perturbed section, and a difference in width between the width of the first waveguide section and the first perturbed section is formed to be different from a difference in width between the width of the second waveguide section and the second perturbed section.

14. The method according to claim 11, whereby the perturbation period of each of the waveguide antennas is determined based on the operating wavelength of the optical signal received by the waveguide antenna array, a refractive index of a superstrate of the waveguide antenna array, an effective refractive index of a mode propagating in the waveguide antenna and an emission angle of the waveguide antenna.

15. The method according to claim 14, whereby the effective refractive index of the mode propagating in the waveguide antenna is determined based on an effective refractive index of a mode propagating in the waveguide section of the waveguide antenna, an effective refractive index of a mode propagating in the perturbed section of the waveguide antenna and a duty cycle of the waveguide antenna.

16. The method according to claim 15, whereby an optimal width of the first perturbed section and an optimal width of the second perturbed section are determined based on iterations of the widths of the first and second perturbed sections that allow the first and second waveguide antennas to have similar power emission rates and similar emission angles when the optical signal was received by the waveguide antenna array.

17. The method according to claim 16, whereby a Particle Swarm Optimization (PSO) algorithm is used to iterate and optimize the widths of the first and second perturbed sections, whereby an objective function of the PSO algorithm is to minimize differences in power emission rates and emission angles between the first and second waveguide antennas when the optical signal was received by the waveguide antenna array.

18. The method according to claim 11 further comprising:
forming a third waveguide antenna having periodic perturbations along a longitudinal axis of the third waveguide antenna, wherein each perturbation period of the third waveguide antenna comprises a third waveguide section and a third perturbed section;
whereby a pitch between the first, second and third waveguide antenna is formed to be no more than half an operating wavelength of an optical signal to be received by the waveguide antenna array,
whereby a width of the third waveguide section is formed to be different from the widths of the first and second waveguide sections, and
whereby the perturbation period of the third waveguide antenna is formed to be different from the perturbation periods of the first and second waveguide antennas.

19. The method according to claim 11 wherein each of the waveguide sections of the waveguide antennas are formed with a width between 200 nm and 500 nm.

20. An optical phased array system comprising:
a plurality of waveguide antenna arrays, each waveguide antenna array comprising:
a first waveguide antenna having periodic perturbations along a longitudinal axis of the first waveguide antenna, wherein each perturbation period of the first waveguide antenna comprises a first waveguide section and a first perturbed section; and
a second waveguide antenna having periodic perturbations along a longitudinal axis of the second waveguide antenna, wherein each perturbation period of the second waveguide antenna comprises a second waveguide section and a second perturbed section,
whereby a pitch between the first and second waveguide antenna is equal or less than half an operating wavelength of an optical signal to be received by the waveguide antenna array,
whereby a width of the first waveguide section is different from a width of the second waveguide section, and
whereby the perturbation period of the first waveguide antenna is different from the perturbation period of the second waveguide antenna.
